(19) United States
(12) Patent Application Publication
(10) Pub. No.: US 2024/0185192 A1
(43) Pub. Date: Jun. 6, 2024

(54) RECURSIVE DISTRIBUTED LEDGER FOR CRYPTOCURRENCY

(71) Applicant: Bank of America Corporation, Charlotte, NC (US)

(72) Inventors: Steven Greene, New York, NY (US); Jayachandra Varma, Irving, TX (US); Siten Sanghvi, Westfield, NJ (US); Prabhat Ranjan, Plano, TX (US)

(21) Appl. No.: 18/073,736

(22) Filed: Dec. 2, 2022

(51) Int. Cl. G06Q 20/06; G06F 16/178

(52) U.S. Cl. CPC G06Q 20/0658; G06F 16/1787

(57) ABSTRACT

Aspects of the disclosure relate to cryptocurrency. A computing platform may synchronize a database with another database to store account information for a user, which may include establishing a distributed ledger to store the account information, and where the account information includes a balance of fiat currency for the user. The computing platform may receive a request to transfer custody of cryptocurrency, on behalf of the user, to an enterprise organization corresponding to the computing platform. The computing platform may store, using a wrapper database integrated with the database, information of the custody of the cryptocurrency. The computing platform may receive, from a user device of the user, an event processing request. The computing platform may process, using the distributed ledger, the event processing request using one or more of: the fiat currency or the cryptocurrency.

### BACKGROUND

Aspects of the disclosure relate to cryptocurrency assets. In some instances, individuals may obtain such assets through a cryptocurrency exchange platform. However, in some instances, there might not be a resource for the individual if such cryptocurrency is lost, stolen, and/or otherwise compromised. Accordingly, it may be important to improve the tracing of such cryptocurrency. Additionally, because different cryptocurrencies have different corresponding regulations and/or ancillary costs associated with using them in transactions, the availability and/or value for each cryptocurrency in a given transaction may different. Due to the distributed storage and changing values of such cryptocurrency, it may be difficult to identify such availability and/or value in real time. Accordingly, it may be important to provide an improved mechanism for cryptocurrency selection.

### SUMMARY

Aspects of the disclosure provide effective, efficient, scalable, and convenient technical solutions that address and overcome the technical problems associated with cryptocurrency storage. In accordance with one or more embodiments of the disclosure, a computing platform comprising at least one processor, a communication interface, and memory storing computer-readable instructions may synchronize a database (e.g., a recursive database) with an another database to store account information for a user, which may include establishing a parent distributed ledger to store the account information, and where the account information may include a balance of fiat currency for the user. The computing platform may receive a request to transfer custody of cryptocurrency, on behalf of the user, to an organization corresponding to the computing platform. The computing platform may store, using a wrapper database integrated with the database, information of the custody of the cryptocurrency, which may include: communicating with a cryptocurrency management system to assign a unique address for the cryptocurrency, and storing, in the parent distributed ledger, the unique address, along with a correlation to the user. The computing platform may receive, from a user device, a user, event processing request. The computing platform may process, using the parent distributed ledger, the event processing request using one or more of: the fiat currency or the cryptocurrency.

In one or more instances, the cryptocurrency management system may host a first distributed ledger corresponding to the cryptocurrency, and the other database may host a second distributed ledger corresponding to the fiat currency. In one or more instances, the parent distributed ledger may be a parent ledger to the first distributed ledger and the second distributed ledger.

In one or more examples, the computing platform may send an API call, periodically, to the cryptocurrency management system requesting a current value of the cryptocurrency. The computing platform may receive, from the cryptocurrency management system a value notification indicating the current value of the cryptocurrency. Based on identifying, using the value notification, that the current value of the cryptocurrency has changed, the computing platform may update the parent distributed ledger to reflect a new value of the cryptocurrency.

In one or more instances, the computing platform may convert, after receiving the request to transfer the custody of the cryptocurrency, the cryptocurrency to fiat currency. In one or more instances, the computing platform may receive, from the user device, a claim request corresponding to the cryptocurrency. The computing platform may identify, based on the conversion of the cryptocurrency to fiat currency and using the parent distributed ledger, claim response information. The computing platform may send, to the user device, the claim request response.

In one or more examples, the event processing request may be a request to transfer currency from an account of the user to a different account. In one or more examples, the computing platform may input, into a currency selection model, information of the event processing request, where the currency selection model may be configured to output currency selection information for the event processing request, and where the currency selection information may indicate a type of currency for use in processing the event processing request.

In one or more instances, the currency selection model may be a machine learning model trained using one or more of: geographic information, local cryptocurrency regulations, cryptocurrency values, card transaction costs, exchange rate information, and/or other information. In one or more instances, the computing platform may automatically cause the transfer of the currency from the account of the user to the different account, where transferring the currency may include transferring one or more of: a particular type of cryptocurrency or fiat currency based on the currency selection information, and where processing the event processing request using the transferred currency may cost less than a transfer of other currencies possessed by the user.

These features, along with many others, are discussed in greater detail below.

### BRIEF DESCRIPTION OF THE DRAWINGS

The present disclosure is illustrated by way of example and not limited in the accompanying figures in which like reference numerals indicate similar elements and in which:

FIGS. 1A-1B depict an illustrative computing environment for a recursive and distributed cryptocurrency ledger in accordance with one or more example embodiments;

FIGS. 2A-2D depict an illustrative event sequence for a recursive and distributed cryptocurrency ledger in accordance with one or more example embodiments;

FIG. 3 depicts an illustrative method for a recursive and distributed cryptocurrency ledger in accordance with one or more example embodiments; and

FIG. 4 depicts an illustrative graphical user interface for a recursive and distributed cryptocurrency ledger in accordance with one or more example embodiments.

### DETAILED DESCRIPTION

In the following description of various illustrative embodiments, reference is made to the accompanying drawings, which form a part hereof, and in which is shown, by way of illustration, various embodiments in which aspects of the disclosure may be practiced. In some instances, other embodiments may be utilized, and structural and functional modifications may be made, without departing from the scope of the present disclosure.

It is noted that various connections between elements are discussed in the following description. It is noted that these connections are general and, unless specified otherwise, may be direct or indirect, wired or wireless, and that the specification is not intended to be limiting in this respect.

As a brief introduction to the concepts described further herein, one or more aspects of the disclosure describe creating a parent ledger to store information of both fiat and cryptocurrencies. For example, centralized and decentralized financing may be combined to connect cryptocurrency transactions with credit or debit card transactions. For instance, some transactions could be performed with traditional methods, such as credit or debit card, while others may be performed using cryptocurrency. This may rely on a global blockchain that stores both traditional transactions and crypto transactions (e.g., a ledger of ledgers, aggregator service, or the like). Some arrangements may rely on a dedicated account with links to debit, crypto, and/or other transactions. In some examples, a global wallet may include multiple types of currencies to enable users to choose.

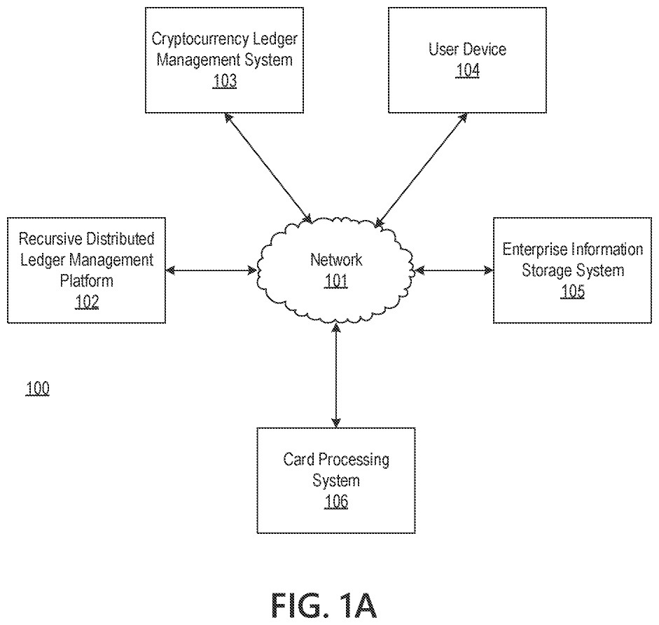

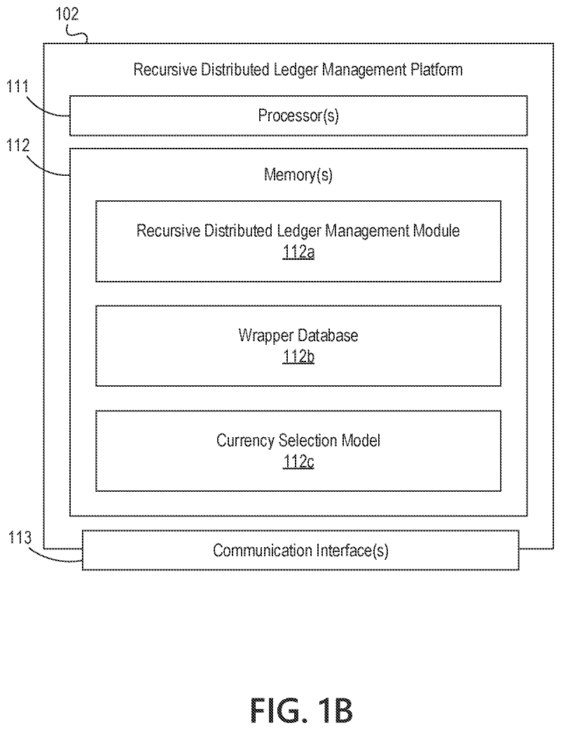

FIGS. 1A-1B depict an illustrative computing environment for a recursive and distributed cryptocurrency ledger in accordance with one or more example embodiments. Referring to FIG. 1A, computing environment 100 may include one or more computer systems. For example, computing environment 100 may include recursive distributed ledger management platform 102, cryptocurrency ledger management system 103, user device 104, enterprise information storage system 105, and card processing system 106.

As described further below, recursive distributed ledger management platform 102 may be a computer system that includes one or more computing devices (e.g., servers, server blades, or the like) and/or other computer components (e.g., processors, memories, communication interfaces) that may be used to perform host a recursive and distributed ledger for cryptocurrency storage. For example, the recursive distributed ledger management platform 102 may be configured to synchronize with an enterprise server (e.g., enterprise information storage system 105) to provide up to date storage information for fiat currencies corresponding to user accounts. The recursive distributed ledger management platform 102 may also be configured to create a wrapper database that corresponds to the stored fiat account information, and may be configured to store cryptocurrency information for corresponding accounts. In some instances, the recursive distributed ledger management platform 102 may employ one or more distributed ledgers to maintain both the fiat and/or cryptocurrency information (e.g., a parent ledger configured with access to child ledgers corresponding to both the enterprise account information and cryptocurrency information). In some instances, the recursive distributed ledger management platform 102 may also be configured to train, host, and/or otherwise maintain a machine learning model configured to identify an optimal (e.g., in terms of minimizing ancillary costs) financial instrument (e.g., fiat currency and/or particular type of cryptocurrency) for use in processing a transaction, and may be configured to automatically execute a transfer of funds corresponding to the identified instrument(s).

The cryptocurrency ledger management system 103 may be a computer system that includes one or more computing devices (e.g., servers, server blades, or the like) and/or other computer components (e.g., processors, memories, communication interfaces) that may be used to host a distributed ledger for a particular cryptocurrency (e.g., current value, address information, custody information, and/or other information). Although a single cryptocurrency ledger management system 103 is illustrated, any number of such systems may be employed without departing from the scope of the disclosure.

User device 104 may be a computing device configured for use in initiating event processing requests. For example, the user device 104 may be a mobile device, laptop computer, desktop computer, tablet, and/or other device that may be used (e.g., by a client of an enterprise corresponding to the recursive distributed ledger management platform 102) to initiate a transfer of fiat and/or cryptocurrency from an account of the client to an account of another. In some instances, the user device 104 may be configured to display one or more graphical user interfaces (e.g., event processing notifications, or the like).

The enterprise information storage system 105 may be a computer system that includes one or more computing devices (e.g., servers, server blades, or the like) and/or other computer components (e.g., processors, memories, communication interfaces) that may be used to store information for an enterprise organization (e.g., a financial institution), such as account information, on behalf of a client. Although illustrated as a separate device from the recursive distributed ledger management platform 102, the enterprise information storage system 105 may, in some instances, be integrated into the recursive distributed ledger management platform 102.

Card processing system 106 may be a system configured to execute event processing requests by accessing account information corresponding to a client's card (e.g., credit card, debit card, and/or otherwise). In some instances, the card processing system 106 may correspond to a merchant and/or other enterprise.

Computing environment 100 also may include one or more networks, which may interconnect recursive distributed ledger management platform 102, cryptocurrency ledger management system 103, user device 104, enterprise information storage system 105, card processing system 106, or the like. For example, computing environment 100 may include a network 101 (which may interconnect, e.g., recursive distributed ledger management platform 102, cryptocurrency ledger management system 103, user device 104, enterprise information storage system 105, card processing system 106 or the like).

In one or more arrangements, recursive distributed ledger management platform 102, cryptocurrency ledger management system 103, user device 104, enterprise information storage system 105, and/or card processing system 106 may be any type of computing device capable of sending and/or receiving requests and processing the requests accordingly. For example, recursive distributed ledger management platform 102, cryptocurrency ledger management system 103, user device 104, enterprise information storage system 105, card processing system 106, and/or the other systems included in computing environment 100 may, in some instances, be and/or include server computers, desktop computers, laptop computers, tablet computers, smart phones, or the like that may include one or more processors, memories, communication interfaces, storage devices, and/or other components. As noted above, and as illustrated in greater detail below, any and/or all of recursive distributed ledger management platform 102, cryptocurrency ledger management system 103, user device 104, enterprise information storage system 105, and card processing system 106 may, in some instances, be special-purpose computing devices configured to perform specific functions.

Referring to FIG. 1B, recursive distributed ledger management platform 102 may include one or more processors 111, memory 112, and communication interface 113. A data bus may interconnect processor 111, memory 112, and communication interface 113. Communication interface 113 may be a network interface configured to support communication between recursive distributed ledger management platform 102 and one or more networks (e.g., network 101, or the like). Memory 112 may include one or more program modules having instructions that when executed by processor 111 cause recursive distributed ledger management platform 102 to perform one or more functions described herein and/or one or more databases that may store and/or otherwise maintain information which may be used by such program modules and/or processor 111. In some instances, the one or more program modules and/or databases may be stored by and/or maintained in different memory units of recursive distributed ledger management platform 102 and/or by different computing devices that may form and/or otherwise make up recursive distributed ledger management platform 102. For example, memory 112 may have, host, store, and/or include recursive distributed ledger management module 112a, wrapper database 112b, and/or currency selection model 112c.

Recursive distributed ledger management module 112a may have instructions that direct and/or cause recursive distributed ledger management platform 102 to execute advanced techniques to provide improved cryptocurrency storage mechanisms. Wrapper database 112b may store information used by recursive distributed ledger management module 112a and/or recursive distributed ledger management platform 102 to provide cryptocurrency storage mechanisms, and/or in performing other functions. Currency selection model 112c may store information that may be used to train, host, and/or otherwise maintain a machine learning model configured to identify currency types for use in processing requested events.

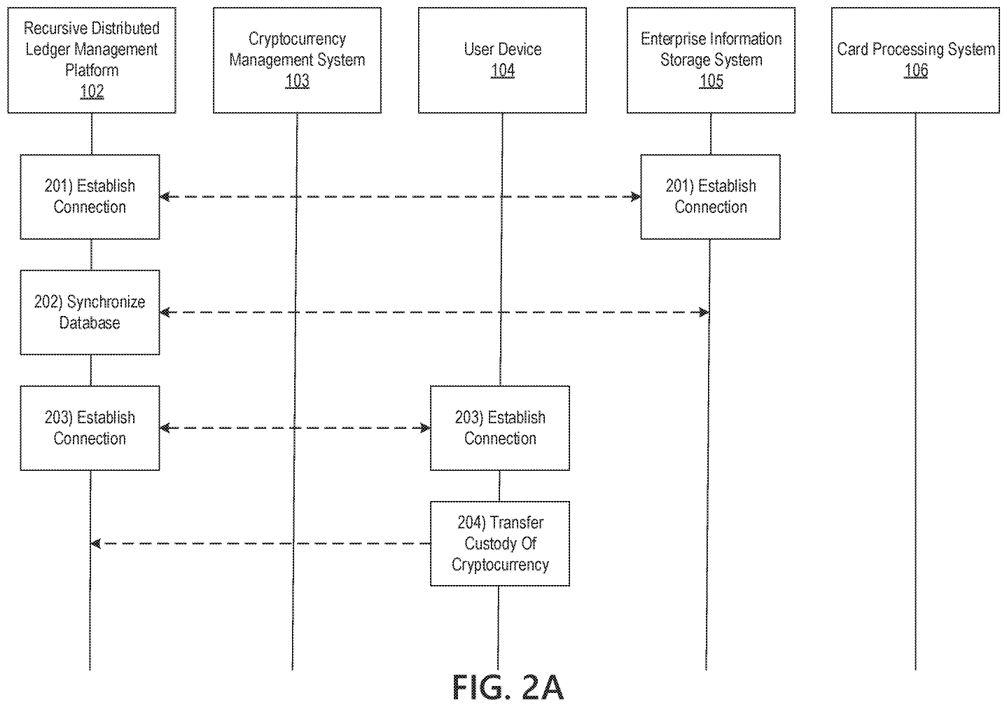

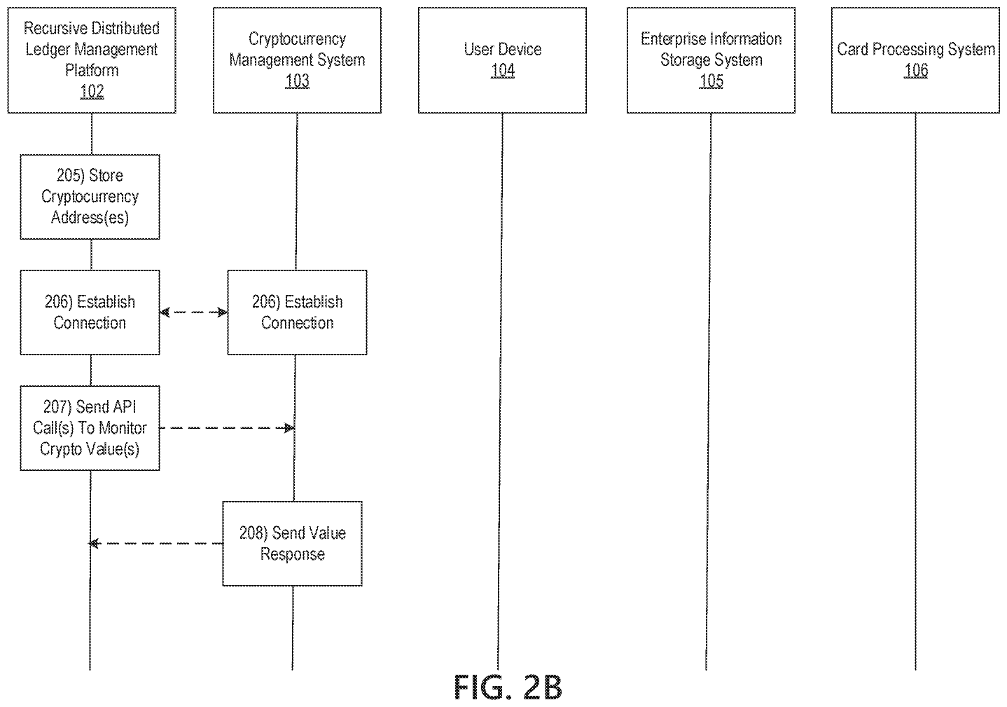

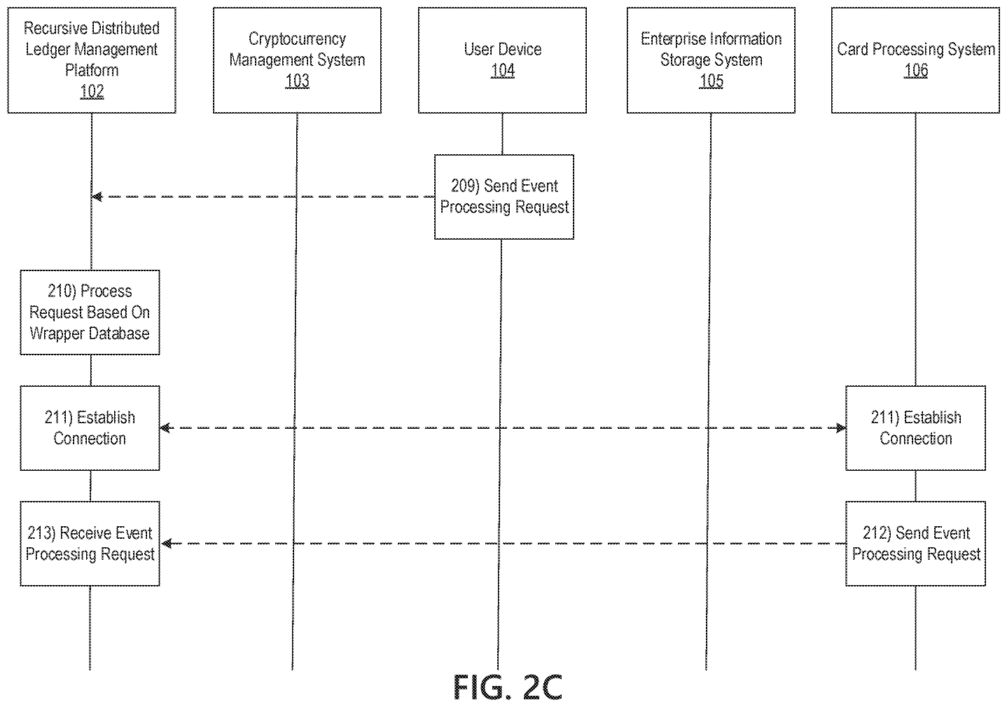

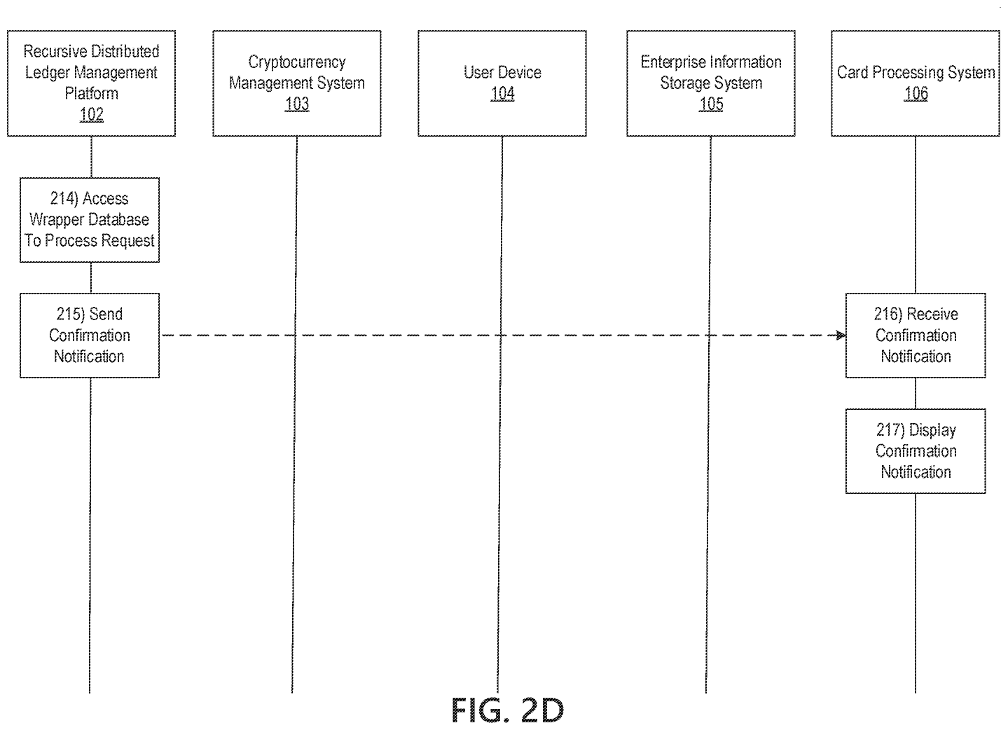

FIGS. 2A-2D depict an illustrative event sequence for a recursive and distributed cryptocurrency ledger in accordance with one or more example embodiments. Referring to FIG. 2A, at step 201, the recursive distributed ledger management platform 102 may establish a connection with the enterprise information storage system 105. For example, the recursive distributed ledger management platform 102 may establish a first wireless data connection with the enterprise information storage system 105 to link the recursive distributed ledger management platform 102 to the enterprise information storage system 105 (e.g., in preparation for synchronizing with the enterprise information storage system 105). In some instances, the recursive distributed ledger management platform 102 may identify whether or not a connection is already established with the enterprise information storage system 105. If a connection is already established with the enterprise information storage system 105, the recursive distributed ledger management platform 102 might not re-establish the connection. If a connection is not yet established with the enterprise information system 105, the recursive distributed ledger management platform 102 may establish the first wireless data connection as described herein.

At step 202, the recursive distributed ledger management platform 102 may synchronize a database of the recursive distributed ledger management platform 102 (e.g., an account database) with the enterprise information storage system 105. For example, the recursive distributed ledger management platform 102 may synchronize account information (e.g., balance, account numbers, and/or other information) for a plurality of users from the enterprise information storage system 105. In some instances, the recursive distributed ledger management platform 102 may store the account database using a first distributed ledger. In some instances, the enterprise information storage system 105 may be integrated into the recursive distributed ledger management platform 102. In these instances, the above described synchronization might not be needed. Rather, the recursive distributed ledger management platform 102 may simply be able to access the information of the enterprise information storage system 105.

At step 203, the user device 104 may establish a connection with the recursive distributed ledger management platform 102. For example, the user device 104 may establish a second wireless data connection with the recursive distributed ledger management platform 102 to link the user device 104 with the recursive distributed ledger management platform 102 (e.g., in preparation for sending event processing requests). In some instances, the user device 104 may identify whether a connection is already established with the recursive distributed ledger management platform 102. If a connection is already established with the recursive distributed ledger management platform 102, the user device 104 might not re-establish the connection. If a connection is not yet established with the recursive distributed ledger management platform 102, the user device 104 may establish the second wireless data connection as described herein.

At step 204, the user device 104 may send a request to transfer custody of cryptocurrency, currently in the custody of a user of the user device 104, to an enterprise corresponding to the recursive distributed ledger management platform 102 (e.g., a financial institution). In some instances, to do so, the user device 104 may further communicate (e.g., directly or via a proxy system) with a cryptocurrency management system (e.g., cryptocurrency management system 103), which may host a distributed ledger corresponding to the cryptocurrency. For example, the user device 104, recursive distributed ledger management platform 102, and/or cryptocurrency management system 103 may communicate to provide the enterprise organization with a unique location and/or address corresponding to the cryptocurrency for the enterprise organization.

In some instances, upon receiving the request to transfer the custody of the cryptocurrency, the recursive distributed ledger management platform 102 may convert the cryptocurrency to fiat currency. For example, the recursive distributed ledger management platform 102 may distribute an amount of fiat currency, corresponding to a current value of the cryptocurrency, into an account of the user, and may maintain custody of the cryptocurrency. In doing so, the recursive distributed ledger management platform 102 may insulate the user from any price fluctuations resulting from changes in value of the cryptocurrency. Additionally, such actions may enable the recursive distributed ledger management platform 102 to provide claim services regarding the cryptocurrency. For example, the recursive distributed ledger management platform 102 may receive a claim request corresponding to the cryptocurrency (e.g., indicating that the user is unable to locate and/or otherwise access the cryptocurrency). In this example, based on the conversion of the cryptocurrency to fiat currency, the recursive distributed ledger management platform 102 may be able to access the current value of the cryptocurrency (e.g., using the distributed ledgers), and may provide the corresponding value of the cryptocurrency to the individual using fiat currency. Additionally or alternatively, the recursive distributed ledger management platform 102 may provide the ability to both deposit and withdraw cryptocurrency, provide instant conversion to fiat currency (which may, in some instances, be a local currency for the user), provide lending services based on the cryptocurrency assets, and/or perform other actions.

In some instances, the recursive distributed ledger management platform 102 may be uniquely positioned to provide such services by having access to both the cryptocurrency and fiat accounts for the user. For example, a financial institution and/or other enterprise configured to provide onboarding to customers involving fiat accounts may be able to provide such onboarding for cryptocurrency as well (e.g., in a way that may provide improved crypto tracking when compared to peer to peer network tracking). With regard to lending services, the recursive distributed ledger management platform 102 may be similarly uniquely situated as being able to convert the cryptocurrency assets to a digital dollar (e.g., based on receiving user consent to do so) so as to provide protection against liquidation in the event of a decrease in value of the cryptocurrency.

Referring to FIG. 2B, at step 205, the recursive distributed ledger management platform 102 may store the cryptocurrency address(es) communicated at step 204. For example, the recursive distributed ledger management platform 102 may generate a wrapper database (e.g., wrapper database 11b), which may e.g., be tied to the account database described above at step 202, and may store the cryptocurrency address(es) therein. In some instances, this wrapper database may be a second distributed ledger, different than the first distributed ledger, that may identify cryptocurrency assets for the user (e.g., rather than fiat assets identified in the first distributed ledger). In some instances, the recursive distributed ledger management platform 102 may generate, store, and/or otherwise maintain a parent ledger, which may, e.g., be linked to the first and/or second distributed ledgers as child ledgers. In doing so, the recursive distributed ledger management platform 102 may store, using a single database and/or ledger, both fiat and cryptocurrency assets for the user.

At step 206, the recursive distributed ledger management platform 102 may establish a connection with the cryptocurrency management system 103. For example, the recursive distributed ledger management platform 102 may establish a third wireless data connection with the cryptocurrency management system 103 to link the recursive distributed ledger management platform 102 (e.g., in preparation for sending application programming interface (API) calls). In some instances, the recursive distributed ledger management platform 102 may identify whether or not a connection is already established with the cryptocurrency management system 103. If a connection is already established, the recursive distributed ledger management platform 102 might not re-establish the connection. If a connection is not yet established, the recursive distributed ledger management platform 102 may establish the third wireless data connection as described herein.

At step 207, the recursive distributed ledger management platform 102 may send one or more API calls to the cryptocurrency management system 103 requesting updated values of the cryptocurrency values. Although communication to a single cryptocurrency management system 103 is shown, any number of such communications may be sent to any number of cryptocurrency management systems without departing from the scope of the disclosure. For example, the user may have multiple types of cryptocurrency, and thus API calls may be sent to the management systems for each type. In some instances, the recursive distributed ledger management platform 102 may send the one or more API calls via the communication interface 113 and while the third wireless data connection is established. In some instances, the recursive distributed ledger management platform 102 may send the API calls at a predetermined interval.

At step 208, the cryptocurrency management system 103 may send a response to the API call indicating a current value of the cryptocurrency. In some instances, the API response may indicate that a value of the cryptocurrency has increased, decreased, or remained the same. In some instances, the cryptocurrency management system 103 may send the API response while the third wireless data connection is established. Upon receiving the API response, the recursive distributed ledger management platform 102 may update the parent ledger and/or the second distributed ledger to indicate any identified change in value for the cryptocurrency.

Referring to FIG. 2C, at step 209, the user device 104 may send an event processing request to the recursive distributed ledger management platform 102. For example, the user device 104 may send a request to execute a payment, transfer funds, and/or otherwise conduct a transaction involving fiat and/or cryptocurrency. In some instances, the user device 104 may send the event processing request to the recursive distributed ledger management platform 102 while the second wireless data connection is established.

At step 210, the recursive distributed ledger management platform 102 may process the request using the wrapper database. For example, the recursive distributed ledger management platform 102 may identify cryptocurrency tied and/or otherwise linked to the user (e.g., by accessing the wrapper database and identifying the address of the corresponding cryptocurrency), and may process the requested event using the identified cryptocurrency. Once processed, the recursive distributed ledger management platform 102 may modify the parent and/or second distributed ledger to reflect the event (e.g., by modifying an existing element of the ledger(s) and/or adding a new element to the ledger(s)).

At step 211, the card processing system 106 may establish a connection with the recursive distributed ledger management platform 102. For example, the card processing system 106 may establish a fourth wireless data connection with the recursive distributed ledger management platform 102 to link the card processing system 106 to the recursive distributed ledger management platform 102 (e.g., in preparation for sending event processing requests). In some instances, the card processing system 106 identify whether or not a connection is already established with the recursive distributed ledger management platform 102. If a connection is already established with the recursive distributed ledger management platform 102, the card processing system 106 might not re-establish the connection. If a connection is not yet established with the recursive distributed ledger management platform 102, the card processing system 106 may establish the fourth wireless data connection as described herein.

At step 212, the card processing system 106 may send a second event processing request to the recursive distributed ledger management platform 102 (e.g., a request to transfer fiat and/or cryptocurrency funds from an account of the user to a different account (such as a merchant account, or the like)). In some instances, the card processing system 106 may be located in a different geographic location than a location in which the user resides. For example, the card processing system 106 may be located in a foreign country, which may, in some instances cause a transaction cost to be applied to the use of various types of currency and/or may have regulations preventing the use of certain cryptocurrency for payment and/or imposing ancillary costs to execute transactions using the cryptocurrency. In some instances, the card processing system 106 may send the second event processing request to the recursive distributed ledger management platform 102 while the fourth wireless data connection is established.

At step 213, the recursive distributed ledger management platform 102 may receive the second event processing request sent at step 212. For example, the distributed ledger management platform 102 may receive the second event processing request via the communication interface 113 and while the fourth wireless data connection is established.

Referring to FIG. 2D, at step 214, the recursive distributed ledger management platform 102 may access the wrapper database to process the second event processing request. For example, the recursive distributed ledger management platform 102 may identify cryptocurrency tied and/or otherwise linked to the user (e.g., by accessing the wrapper database and identifying the address of the corresponding cryptocurrency), and may process the second requested event using the identified cryptocurrency (e.g., as described above at step 210).

In some instances, the recursive distributed ledger management platform 102 may additionally access a currency selection model to identify which currency to access via the wrapper database. For example, the recursive distributed ledger management platform 102 may have previously trained the currency selection model using geographic information, local cryptocurrency regulations, cryptocurrency values, card transaction costs, exchange rate information, time information, historical market trends, and/or other information (e.g., to identify, for a given requested event, a currency that, if used to process the event, would result in the lowest cost and would be eligible for use). For example, the currency selection model may be trained to first identify, based on the given event processing request, eligible currency solutions. For example, the currency selection model may identify, based on a location corresponding to the given event processing request, currencies eligible for use in processing the given event processing request (e.g., some jurisdictions might not recognize and/or otherwise permit the use of certain cryptocurrencies, and thus such cryptocurrencies might not be factored in for selection). Additionally or alternatively, the currency selection model may identify, based on an amount of the given event processing request, currencies available for use (e.g., does the user possess a sufficient amount of the currency to fulfill the event processing request). In some instances, this identification may take into account minimum account balance thresholds. For example, if the user does have an amount of a cryptocurrency sufficient to satisfy the event processing request, but using this amount would reduce their amount of the cryptocurrency below the minimum account balance threshold, the given cryptocurrency may be considered ineligible for use in processing the request. Additionally or alternatively, a liquidation order may be identified, and used to train the currency selection model (e.g., on a preferred order of cryptocurrencies to liquidate. In some instances, the thresholds and/or liquidation order may be set automatically and/or by the user. In some instances, if the user does not possess a sufficient amount of a given currency (e.g., crypto or fiat) to satisfy the event processing request, it might not be flagged as ineligible by the currency selection model, but may instead be combined with other currencies to achieve the necessary value.

The currency selection model may be further trained to, after identifying eligible currencies, identify a lowest cost option. For example, the currency selection model may be trained to identify, based on currency values and/or any associated payment costs, an optimal currency for use in processing a given request. For example, if a processing cost associated with use of a first cryptocurrency to execute a payment is higher than the processing cost associated with the use of a second cryptocurrency, the currency selection model may be configured to select the second cryptocurrency. In some instances, the currency selection model may be trained to be predictive in nature, and may take into account projected cryptocurrency values. For example, the currency selection model may be trained to predict future values of cryptocurrencies, and may be trained to prioritize the use of a cryptocurrency with a lower projected future value (e.g., if cryptocurrency #1 is predicted to decrease in value, whereas cryptocurrency #2 is predicted to increase, cryptocurrency #1 may be selected to perform the given request).

In some instances, in training the currency selection model, the recursive distributed ledger management platform 102 may train a supervised learning model (e.g., support-vector machines, linear regression, logistic regression, decision tree, neural networks, and/or other supervised learning model), unsupervised learning model (clustering, anomaly detection, and/or other unsupervised learning models), and/or other machine learning model.

Accordingly, at step 214, the recursive distributed ledger management platform 102 may input the second event processing request into the currency selection model, which may cause the currency selection model to output one or more currencies (e.g., one or more fiat currencies, cryptocurrencies and/or a mixture of currencies) for use in processing the second event processing request. Once identified, the recursive distributed ledger management platform 102 may access the identified currencies using the wrapper database for use in processing the second request event (e.g., by transferring the currencies to an account of an enterprise corresponding to the card processing system 106).

In some instances, the recursive distributed ledger management platform 102 may establish a dynamic feedback loop so as to continuously and dynamically refine the currency selection model to improve accuracy of the model in selecting currency. In some instances, the recursive distributed ledger management platform 102 may update the currency selection model based on the currency output for the second event processing request and/or any user feedback received (e.g., user feedback received indicating that the initially identified currency should be used, or whether the model should select an alternative currency).

Once processed, the recursive distributed ledger management platform 102 may modify the parent and/or second distributed ledger to reflect the event (e.g., by modifying an existing element of the ledger(s) and/or adding a new element to the ledger(s)). In some instances, actions described at step 214 (e.g., with regard to the currency selection model) may similarly be applied with regard to event processing requests from the user device 104 (e.g., the event processing request sent at step 209) without departing from the scope of the disclosure.

At step 215, the recursive distributed ledger management platform 102 may send a confirmation notification to the card processing system 106, indicating that the second requested event has been processed. In some instances, the confirmation notification may also indicate a type of currency used to process the second requested event. In some instances, the recursive distributed ledger management platform 102 may send the confirmation notification via the communication interface 113 and while the fourth wireless data connection is established. In some instances, the recursive distributed ledger management platform 102 may also send one or more commands directing the card processing system 106 to display the confirmation notification.

At step 216, the card processing system 106 may receive the confirmation notification sent at step 215. For example, the card processing system 106 may receive the confirmation notification while the fourth wireless data connection is established. In some instances, the card processing system 106 may also receive the one or more commands directing the card processing system 106 to display the confirmation notification.

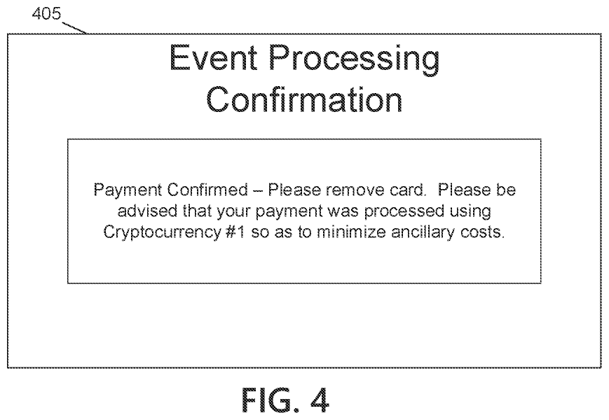

At step 217, based on or in response to the one or more commands directing the card processing system 106 to display the confirmation notification, the card processing system 106. For example, the card processing system 106 may display a graphical user interface similar to graphical user interface 405, which is shown in FIG. 4. In some instances, the confirmation notification may be sent to and/or otherwise displayed by other devices (e.g., user device 104 and/or other device) without departing from the scope of the disclosure.

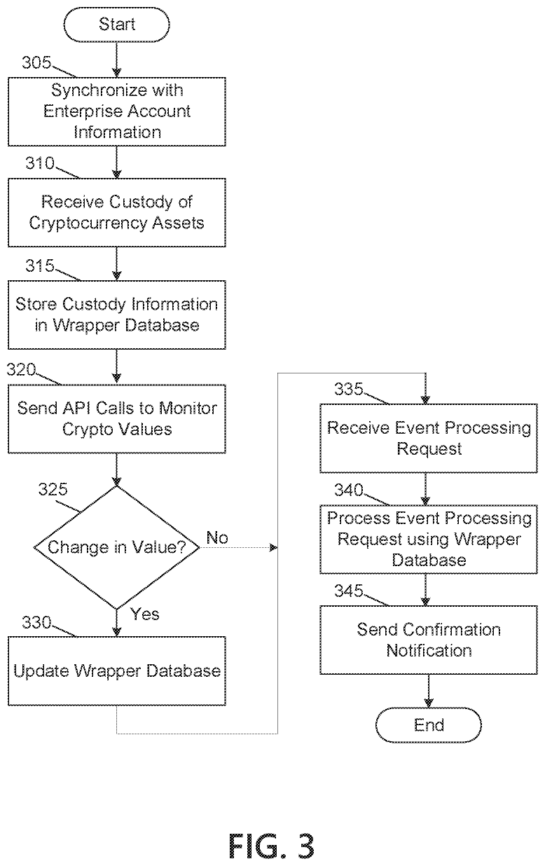

FIG. 3 depicts an illustrative method for a recursive and distributed cryptocurrency ledger in accordance with one or more example embodiments. Referring to FIG. 3, at step 305, a computing platform having at least one processor, a communication interface, and memory may synchronize with enterprise account information. At step 310, the computing platform may receive custody of one or more cryptocurrency assets. At step 315, the computing platform may store the custody information in a wrapper database. At step 320, the computing platform may send one or more API calls to monitor values of the cryptocurrency assets. At step 325, the computing platform may identify whether or not a change in value has occurred for the cryptocurrency assets. If a change has occurred, the computing platform may proceed to step 330. Otherwise, the computing platform may proceed directly to step 335. At step 330, the computing platform may update the wrapper database based on the change.

At step 335, the computing platform may receive an event processing request. At step 340, the computing platform may process the event processing request using the wrapper database and a currency selection model. At step 345, the computing platform may send a processing confirmation notification for display.

One or more aspects of the disclosure may be embodied in computer-usable data or computer-executable instructions, such as in one or more program modules, executed by one or more computers or other devices to perform the operations described herein. Generally, program modules include routines, programs, objects, components, data structures, and the like that perform particular tasks or implement particular abstract data types when executed by one or more processors in a computer or other data processing device. The computer-executable instructions may be stored as computer-readable instructions on a computer-readable medium such as a hard disk, optical disk, removable storage media, solid-state memory, RAM, and the like. The functionality of the program modules may be combined or distributed as desired in various embodiments. In addition, the functionality may be embodied in whole or in part in firmware or hardware equivalents, such as integrated circuits, application-specific integrated circuits (ASICs), field programmable gate arrays (FPGA), and the like. Particular data structures may be used to more effectively implement one or more aspects of the disclosure, and such data structures are contemplated to be within the scope of computer executable instructions and computer-usable data described herein.

Various aspects described herein may be embodied as a method, an apparatus, or as one or more computer-readable media storing computer-executable instructions. Accordingly, those aspects may take the form of an entirely hardware embodiment, an entirely software embodiment, an entirely firmware embodiment, or an embodiment combining software, hardware, and firmware aspects in any combination. In addition, various signals representing data or events as described herein may be transferred between a source and a destination in the form of light or electromagnetic waves traveling through signal-conducting media such as metal wires, optical fibers, or wireless transmission media (e.g., air or space). In general, the one or more computer-readable media may be and/or include one or more non-transitory computer-readable media.

As described herein, the various methods and acts may be operative across one or more computing servers and one or more networks. The functionality may be distributed in any manner, or may be located in a single computing device (e.g., a server, a client computer, and the like). For example, in alternative embodiments, one or more of the computing platforms discussed above may be combined into a single computing platform, and the various functions of each computing platform may be performed by the single computing platform. In such arrangements, any and/or all of the above-discussed communications between computing platforms may correspond to data being accessed, moved, modified, updated, and/or otherwise used by the single computing platform. Additionally or alternatively, one or more of the computing platforms discussed above may be implemented in one or more virtual machines that are provided by one or more physical computing devices. In such arrangements, the various functions of each computing platform may be performed by the one or more virtual machines, and any and/or all of the above-discussed communications between computing platforms may correspond to data being accessed, moved, modified, updated, and/or otherwise used by the one or more virtual machines.

Aspects of the disclosure have been described in terms of illustrative embodiments thereof. Numerous other embodiments, modifications, and variations within the scope and spirit of the appended claims will occur to persons of ordinary skill in the art from a review of this disclosure. For example, one or more of the steps depicted in the illustrative figures may be performed in other than the recited order, and one or more depicted steps may be optional in accordance with aspects of the disclosure.

What is claimed is:

1. A computing platform comprising:
at least one processor;
a communication interface communicatively coupled to the at least one processor; and
memory storing computer-readable instructions that, when executed by the at least one processor, cause the computing platform to:
synchronize a database with another database containing account information for a user, wherein synchronizing the database comprises establishing a parent distributed ledger to store the account information, and wherein the account information includes a balance of fiat currency for the user;
receive a request to transfer custody of cryptocurrency, on behalf of the user, to an enterprise organization corresponding to the computing platform;
store, using a wrapper database integrated with the database, information of the custody of the cryptocurrency, wherein storing the information of the custody of the cryptocurrency comprises:
communicating with a cryptocurrency management system to assign a unique address for the cryptocurrency, and
storing, in the parent distributed ledger, the unique address, along with a correlation to the user;
receive, from a user device of the user, an event processing request; and
process, using the parent distributed ledger, the event processing request using one or more of: the fiat currency or the cryptocurrency.

2. The computing platform of claim 1, wherein the cryptocurrency management system hosts a first distributed ledger corresponding to the cryptocurrency, and wherein the other database hosts a second distributed ledger corresponding to the fiat currency.

3. The computing platform of claim 2, wherein the parent distributed ledger comprises a parent ledger to the first distributed ledger and the second distributed ledger.

4. The computing platform of claim 1, wherein the memory stores additional computer-readable instructions that, when executed by the one or more processors, cause the computing platform to:
send an API call, periodically, to the cryptocurrency management system requesting a current value of the cryptocurrency;
receive, from the cryptocurrency management system a value notification indicating the current value of the cryptocurrency; and
based on identifying, using the value notification, that the current value of the cryptocurrency has changed, update the parent distributed ledger to reflect a new value of the cryptocurrency.

5. The computing platform of claim 1, wherein the memory stores additional computer-readable instructions that, when executed by the one or more processors, cause the computing platform to:
convert, after receiving the request to transfer the custody of the cryptocurrency, the cryptocurrency to fiat currency.

6. The computing platform of claim 5, wherein the memory stores additional computer-readable instructions that, when executed by the one or more processors, cause the computing platform to:
receive, from the user device, a claim request corresponding to the cryptocurrency;
identify, based on the conversion of the cryptocurrency to fiat currency and using the parent distributed ledger, claim response information; and
send, to the user device, the claim request response.

7. The computing platform of claim 1, wherein the event processing request comprises a request to transfer currency from an account of the user to a different account.

8. The computing platform of claim 7, wherein the memory stores additional computer-readable instructions that, when executed by the one or more processors, cause the computing platform to:
input, into a currency selection model, information of the event processing request, wherein the currency selection model is configured to output currency selection information for the event processing request, wherein the currency selection information indicates a type of currency for use in processing the event processing request.

9. The computing platform of claim 8, wherein the currency selection model comprises a machine learning model trained using one or more of: geographic information, local cryptocurrency regulations, cryptocurrency values, card transaction costs, or exchange rate information.

10. The computing platform of claim 8, automatically cause the transfer of the currency from the account of the user to the different account, wherein transferring the currency comprises transferring one or more of: a particular type of cryptocurrency or fiat currency based on the currency selection information, wherein processing the event processing request using the transferred currency costs less than a transfer of other currencies possessed by the user.

11. A method comprising:
at a computing platform comprising at least one processor, a communication interface, and memory:
synchronizing a database with a database containing account information for a user, wherein synchronizing the database comprises establishing a parent distributed ledger to store the account information, and wherein the account information includes a balance of fiat currency for the user;
receiving a request to transfer custody of cryptocurrency, on behalf of the user, to an enterprise organization corresponding to the computing platform;
storing, using a wrapper database integrated with the database, information of the custody of the cryptocurrency, wherein storing the information of the custody of the cryptocurrency comprises:
communicating with a cryptocurrency management system to assign a unique address for the cryptocurrency, and
storing, in the parent distributed ledger, the unique address, along with a correlation to the user;
receiving, from a user device of the user, an event processing request; and
processing, using the parent distributed ledger, the event processing request using one or more of: the fiat currency or the cryptocurrency.

12. The method of claim 11, wherein the cryptocurrency management system hosts a first distributed ledger corresponding to the cryptocurrency, and wherein the other database hosts a second distributed ledger corresponding to the fiat currency.

13. The method of claim 12, wherein the parent distributed ledger comprises a parent ledger to the first distributed ledger and the second distributed ledger.

14. The method of claim 11, further comprising:
sending an API call, periodically, to the cryptocurrency management system requesting a current value of the cryptocurrency;
receiving, from the cryptocurrency management system a value notification indicating the current value of the cryptocurrency; and
based on identifying, using the value notification, that the current value of the cryptocurrency has changed, updating the parent distributed ledger to reflect a new value of the cryptocurrency.

15. The method of claim 11, further comprising:
converting, after receiving the request to transfer the custody of the cryptocurrency, the cryptocurrency to fiat currency.

16. The method of claim 15, further comprising:
receiving, from the user device, a claim request corresponding to the cryptocurrency;
identifying, based on the conversion of the cryptocurrency to fiat currency and using the parent distributed ledger, claim response information; and
sending, to the user device, the claim request response.

17. The method of claim 11, wherein the event processing request comprises a request to transfer currency from an account of the user to a different account.

18. The method of claim 17, further comprising:
inputting, into a currency selection model, information of the event processing request, wherein the currency selection model is configured to output currency selection information for the event processing request, wherein the currency selection information indicates a type of currency for use in processing the event processing request.

19. The method of claim 18, wherein the currency selection model comprises a machine learning model trained using one or more of: geographic information, local cryptocurrency regulations, cryptocurrency values, card transaction costs, or exchange rate information.

20. One or more non-transitory computer-readable media storing instructions that, when executed by a computing platform comprising at least one processor, a communication interface, and memory, cause the computing platform to:
synchronize a database with a database containing account information for a user, wherein synchronizing the database comprises establishing a parent distributed ledger to store the account information, and wherein the account information includes a balance of fiat currency for the user;
receive a request to transfer custody of cryptocurrency, on behalf of the user, to an enterprise organization corresponding to the computing platform;
store, using a wrapper database integrated with the database, information of the custody of the cryptocurrency, wherein storing the information of the custody of the cryptocurrency comprises:
communicating with a cryptocurrency management system to assign a unique address for the cryptocurrency, and
storing, in the parent distributed ledger, the unique address, along with a correlation to the user;
receive, from a user device of the user, an event processing request; and
process, using the parent distributed ledger, the event processing request using one or more of: the fiat currency or the cryptocurrency.
